(19) United States
(12) Patent Application Publication
(10) Pub. No.: US 2026/0041089 A1
(43) Pub. Date: Feb. 12, 2026

(54) PLANT BIOSTIMULANT AND METHODS OF MAKING AND USING SAME

(71) Applicant: Solugen, Inc., Houston, TX (US)

(72) Inventors: Jun Su An, Houston, TX (US); Jihye Kim, Sugar Land, TX (US); Darlen Galicia, Houston, TX (US); Catherine Gonzalez, Houston, TX (US); Frederyk Ngantung, Houston, TX (US); Vatren Jurin, Overland Park, KS (US); Abdul Siraj, Sugar Land, TX (US)

(73) Assignee: Solugen, Inc., Houston, TX (US)

(21) Appl. No.: 19/101,583

(22) PCT Filed: Aug. 7, 2023
(86) PCT No.: PCT/US2023/071780

§ 371 Date: Feb. 5, 2025

Related U.S. Application Data
(60) Provisional application No. 63/370,796, filed on Aug. 9, 2022.

(51) Int. Cl. A01N 37/36; A01N 25/02; A01P 21/00

(52) U.S. Cl. CPC A01N 37/36; A01N 25/02; A01P 21/00

(57) ABSTRACT

A composition including (i) a sugar, a sugar derivative or combination thereof; (ii) an optional nutrient salt; and (iii) an optional solvent. A method of treatment comprising contacting an agricultural material with a composition comprising (i) a sugar, a sugar derivative or combination thereof; (ii) an optional nutrient salt; (iii) an optional performance enhancing additive; and (iv) a solvent wherein treatment of the agricultural material results in increased viability of a plant associated with the agricultural material.

### CROSS-REFERENCE TO RELATED APPLICATIONS

This application is a 35 U.S.C. § 371 national stage application of PCT/US2023/071780 filed Aug. 7, 2023, and entitled “Plant Biostimulant and Methods of Making and Using Same,” which claims priority to U.S. Provisional Application No. 63/370,796 filed Aug. 9, 2022 and entitled “Plant Biostimulant and Methods of Making and Using Same,” each of which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The present disclosure relates generally to compositions and methods for use in agricultural processes. More specifically, the present disclosure relates to stimulate natural plant processes.

### BACKGROUND

The agricultural sector is facing the concomitant challenges of raising productivity to feed the growing global population while reducing the sector's environmental impact on ecosystems. Agricultural endeavors face increasing pressures due to issues such as climate change, soil erosion, and biodiversity loss and from consumers' changing tastes in food and concerns about how it is produced. This is in addition to the natural world that farming works with where plants, pests, and diseases continue to pose their own challenges.

Fertilizers and pesticides represent a powerful tool for growers to increase yield and guarantee continuous productivity throughout the seasons under both optimal and suboptimal conditions, however, these materials contribute to the sector's concern regarding environmental impact. While modern agriculture provides a number of solutions, the outcome is not always the same because each farm is unique: different landscapes, soils, available technology and potential yields.

### BRIEF DESCRIPTION OF THE DRAWINGS

For a detailed description of the aspects of the disclosed processes and systems, reference will now be made to the accompanying drawings in which:

FIG. 1 is a schematic view of an equilibrium reaction between glucaric acid and its lactones.

FIG. 2 is a schematic view of an equilibrium reaction between gluconolactone and gluconic acid.

FIG. 3 is a process flow diagram illustrating an embodiment of a method for manufacturing a plant biostimulant composition in accordance with principles described herein.

FIG. 4A illustrates photographs taken at the indicated time interval of radish seed pots either untreated or treated with a plant biostimulant compositions of the type disclosed herein. The plants treated with a plant biostimulant composition of the type disclosed herein germinated faster than the control sample.

FIG. 4B illustrates photographs taken at the indicated time interval of radish seed pots either untreated or treated with a plant biostimulant compositions of the type disclosed herein.

FIG. 4C illustrates photographs taken at the indicated time interval of radish seed pots either untreated or treated with a plant biostimulant compositions of the type disclosed herein. The samples treated with a PBC exhibited an increased dry biomass, an increased level of iron from nutrition analysis as noticed with greener leaves in the figure with thicker and shorter shoots when compared to the control sample.

FIG. 5 depicts a bar graph of average dry plant biomass at harvest for samples with and without treatment with a plant biostimulant composition of the type disclosed herein.

FIG. 6 depicts a graph of the number of seeds germinated for tomato seedlings in the presence of a control or a PBC of the type disclosed herein.

FIG. 7 depicts a graph of the number of fruits (tomatoes) produced as a function of the amount of treatment applied when compared to a control treatment.

FIG. 8 depicts a graph of whole plant weight of lettuce plants untreated or treated with a plant biostimulant composition of the type disclosed herein.

FIG. 9 depicts graphs of root length and biomass for microgreen radish plants treated with a plant biostimulant composition of the type disclosed herein and subject to drought conditions.

### SUMMARY

A composition comprising (i) a sugar, a sugar derivative or combination thereof; (ii) an optional nutrient salt; and (iii) an optional solvent.

A method of treatment comprising contacting an agricultural material with a composition comprising (i) a sugar, a sugar derivative or combination thereof; (ii) an optional nutrient salt; (iii) an optional performance enhancing additive and (iv) a solvent wherein treatment of the agricultural material results in increased viability of a plant associated with the agricultural material.

### DETAILED DESCRIPTION

As previously described, fertilizers and pesticides provide benefits but contribute to the agricultural sector's concern regarding environmental impacts. In addition, the benefits of fertilizers and pesticides may not always be the same as each farm is unique. Accordingly, an ongoing need exists for novel compounds that are characterized by (i) consistent production quality: (ii) consistent and effective in improving plant viability; (iii) ability to affect pH, and (iv) a reduction in environmental impact on ecosystems.

Disclosed herein are plant biostimulant compositions (PBCs) and methods of making and using same. In one or more aspects, the PBC comprises a plant biostimulant. Herein, a plant biostimulant refers to a substance or micro-organism that, when applied to seeds, plants, or the plant rhizosphere, stimulates one or more natural processes that enhance or benefit nutrient uptake, improves plant tolerance against a wide range of abiotic stressors, enhances flowering, seed germination, plant growth, fruit set, crop productivity, nutrient use efficiency (NUE), tolerance to abiotic stress, crop quality, crop yield or combinations thereof. The improvements that plant biostimulants may confer on a plant are collectively referred to as improvements in plant viability. In an aspect, the PBC comprises (i) a sugar or sugar derivative (SSD) (ii) an optional nutrient salt and (iii) an optional solvent.

In an aspect, the PBC comprises an SSD. Herein, the SSD may also function as a chelating agent or sequestering agent which is a molecule capable of bonding or forming a complex with a metal. The SSD may be characterized as a ligand that contains two or more electron-donating groups so that more than one bond is formed between an atom on each of the electron donating groups of the ligand to the metal. This bond can also be dative or a coordinating covalent bond meaning each electronegative atom provides both electrons to form bonds to the metal center. In one or more aspects, the SSD is able to chelate a metal, as described, and (i) is sourced from a natural resource, (ii) is biodegradable, or (iii) both. In an aspect, the SSD comprises aldonic acid, uronic acid, aldaric acid, or a combination thereof and a counter cation. For example, the SSD may be a mixture of aldaric and uronic acids.

In another aspect, the SSD comprises a glucose oxidation product, a gluconic acid oxidation product, a gluconate, or a combination thereof. The glucose oxidation product, gluconic acid oxidation product, or combination thereof may be buffered to a suitable pH.

Additionally, or alternatively, in one or more aspects, the SSD comprises glucaric acid, gluconic acid, glucuronic acid, glucose oxidation products, gluconic acid oxidation products or a combination thereof. Additionally, or alternatively, in one or more aspects, the SSD comprises disaccharides, oxidized disaccharides, uronic acid, aldaric acid or a combination thereof.

Additionally, or alternatively, in one or more aspects, the SSD comprises gluconic acid, glucaric acid, glucuronic acid, n-keto-acids, C₂ to C₆ diacids or a combination thereof.

Additionally, or alternatively, in one or more aspects, the SSD comprises galactonic acid, galactaric acid, an oxidation product comprising predominantly (e.g., greater than about 50 weight percent) galactonic acid and/or galactaric acid with minor component species of n-keto-acids, C₂ to C₆ diacids or a combination thereof. Additionally, or alternatively, in one or more aspects, the SSD comprises glutamic acid. Additionally, or alternatively, in one or more aspects, the SSD comprises glucodialdose, 2-ketoglucose or a combination thereof.

In aspects SSD comprises a buffered glucose oxidation product, a buffered gluconic acid oxidation product, or combinations thereof. In such aspects, the buffered glucose oxidation product, the buffered gluconic acid oxidation product, or combinations thereof are buffered to a suitable pH. For example, the glucose oxidation product, gluconic acid oxidation product or combination thereof may be buffered to a pH in the range of from about 1 to about 5, alternatively from about 1.5 to about 4.5 or alternatively from about 2 to about 4. Buffering of the SSD may be carried out using any suitable pH adjusting material.

In one or more aspects, an SSD comprises aldonic acid, uronic acid, aldaric acid, a gluconic acid oxidation product, a gluconate, glucaric acid, gluconic acid, glucuronic acid, glucose oxidation products, galactonic acid, galactaric acid, glutamic acid, a lactone of gluconic acid, a lactone of glucaric acid, a lactone of galactaric acid, a lactone of galactonic acid, glucodialdose, 2-ketoglucose, disaccharides, oxidized disaccharides, n-keto-acids, C₂ to C₆ diacids, salts thereof, or combinations thereof.

In one or more aspects, any SSD disclosed herein further comprises a counter-cation such as a Group 1 alkali metal, a Group 2 alkaline earth metal, a Group 8 metal, Group 11 metal, Group 12 metal, or a combination thereof. For example, the counter-cation may comprise silicates, borates, aluminum, calcium, magnesium, ammonium, sodium, potassium, cesium, strontium, zinc, copper, ferric iron, ferrous iron, or a combination thereof.

In an aspect, the SSD comprises a glucose oxidation product, a gluconic acid oxidation product, a gluconate, glucaric acid, an oxidized glucuronolactone, a uronic acid oxidation product, or a combination thereof. Alternatively, the SSD comprises a buffered glucose oxidation product, a buffered gluconic acid oxidation product, or a combination thereof. Alternatively the SSD comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, glycine, salts thereof, lactones thereof and combinations thereof.

In one or more aspects, the SSD comprises less than about 5 wt. % maltose, maltotriose, fructose, higher molecular weight polysaccharides, oxidation products thereof or combinations thereof based on the total weight of the sugar derivative.

In an aspect, the SSD comprises a metal chelation product commercially available from Solugen, Inc. of Houston, Texas as Biochelate™ and NutriValent™.

In one or more aspects, the PBC comprises a sugar. Sugars suitable for inclusion in the PBC include, without limitation, monosaccharides, disaccharides, sucrose, glucose, fructose, lactose, maltose, xylose, ribose, arabinose, lyxose, trehalose, cellobiose, chitobiose, glucosamine, glucose disaccharides of alpha 1-2, glucose disaccharides of alpha 1-3, glucose disaccharides of alpha 1-6, glucose disaccharides of beta 1-2, glucose disaccharides of beta 1-3, glucose disaccharides of beta 1-6, glucose-fructose disaccharides of alpha 1-2, glucose-fructose disaccharides of alpha 1-3, glucose-fructose disaccharides of alpha 1-6, glucose-fructose disaccharides of alpha 1-5, glucose-fructose disaccharides of alpha 1-4, glucose-fructose disaccharides of beta 1-6, mannose disaccharides of alpha 1-2, mannose disaccharides of alpha 1-3, mannose disaccharides of alpha 1-4. mannose disaccharides of alpha 1-6, galactose disaccharides of alpha 1-6,glucose disaccharides of alpha 1-6, fructose disaccharides of alpha 1-6, rhamnose saccharides of alpha 1-6, glucose saccharides of alpha 1-6, fructose saccharides of alpha 1-6, fructose saccharides of beta 1-6, xylobiose disaccharides of beta 1-4, and combinations thereof.

In various aspects, the SSD is present in a PBC in an amount of from about 0.1weight percent (wt. %) to about 99 wt. %, alternatively from about 0.1 wt. % to about 2 wt. %, alternatively from about 45 wt. % to about 99 wt. %, alternatively from about 1 wt. % to about 10 wt. %, or alternatively from about 5 wt. % to about 60 wt. % based on the total weight of the PBC. Herein, all weight percentages are based on the total weight of the composition being described unless indicated otherwise.

In an aspect, the PBC optionally comprises at least one nutrient salt. The nutrient may be a micronutrient. In other aspects, the nutrient is a macronutrient. In an aspect, the nutrient salt comprises humic acids, fulvic acids, salts thereof, or combinations thereof. Herein, humic and fulvic acids refer to the final break-down constituents of the natural decay of plant and animal materials. Humic matter is formed through the chemical and biological humification of plant and animal matter and through the biological activities of micro-organisms. Humic acids are complex molecules. In another aspect, the PBC is applied to form a seed coating material comprising macronutrients and micronutrients derived from humic acids, fulvic acids, salts thereof, or combinations thereof. The macronutrients may comprise nitrogen, phosphorus, potassium, calcium, magnesium, sulfur, amino acids or a combination thereof. The micronutrients may comprise iron, nickel, zinc, boron, manganese, molybdenum, copper, cobalt, or a combination thereof.

In an aspect, nutrient salt cation comprises iron, calcium, boron, magnesium, manganese, copper, zinc, molybdenum, nickel, sodium, potassium, or a combination thereof. In an aspect, the nutrient salt anion comprises phosphates, phosphorous, chloride, sulfates, nitrates, nitrites, oxides, or a combination thereof.

A nutrient salt of the type disclosed herein is optionally present in the PBC in an amount of from about 0.1 wt. % to about 10 wt. %, alternatively from about 0.5 wt. % to about 5 wt. %, alternatively from about 1 wt. % to about 50 wt. % or alternatively from about 0.1wt. % to about 3 wt. %.

In one or more aspects, a PBC of the type disclosed herein comprises a conventional plant biostimulant such as the humic acids disclosed herein or a seaweed extract. Any conventional plant biostimulant compatible with the components of the PBC may be utilized.

In an aspect, the PBC optionally comprises a solvent. Solvents suitable for inclusion in the PBCs disclosed herein include, without limitation, water, a citrate solution, methanol, ethanol, ethylene glycol, propylene glycol, ethylene glycol monobutyl ether, a hydroxide-based pH fluid (e.g., KOH and NaOH), an ammonia solution, a urea solution, or a combination thereof.

In an aspect, the solvent is present in an amount sufficient to meet some user and/or process need (e.g., flow properties). In an aspect, the solvent is present in an effective amount, alternatively, the solvent comprises the remainder of the PBC when all other components of the PBC are accounted for.

In an aspect, the PBC is blended with one or more additional components to provide a material suitable for application to a plant. Hereinafter, this is referred to as a “treatment composition.” In such aspects, the treatment composition comprises the PBC (e.g., SSD, optional nutrient salt, and optional solvent) and at least one additive that may enhance the performance of the PBC (a performance enhancing additive, optional biostimulant of different type).

In one or more aspects, the performance enhancing additive is selected from the group consisting of oxides, nitrates, nitrites, phosphates, sulfates, insecticides, herbicides, fungicides, macronutrients, plant hormones, dry fertilizer, liquid fertilizers, adjuvants, surfactants, oxidizers, biologicals, vitamins, mold inhibitor, absorbent, penetrant, growth regulators, water treatment/irrigation products, and plant hormones. Performance enhancing additives may be included in the PBC singularly or in combination in an amount ranging from about 0.1 wt. % to about 20 wt. %, alternatively from about 5 wt. % to about 30wt. %, alternatively from about 0.1 wt. % to about 10 wt. %, or alternatively from about 25wt. % to about 80 wt. %.

In various aspects, a treatment composition suitable for use in the present disclosure comprises a PBC, a preplant fertilizer, macronutrients, and plant hormones. In one or more aspects, a treatment composition suitable for use in the present disclosure comprises a PBC, a dry fertilizer, and a nitrogen source such as ammonium nitrate or anhydrous ammonia. In one or more aspects, a treatment composition suitable for use in the present disclosure comprises a PBC, a liquid fertilizer, and a nitrogen source such as ammonium nitrate or anhydrous ammonia.

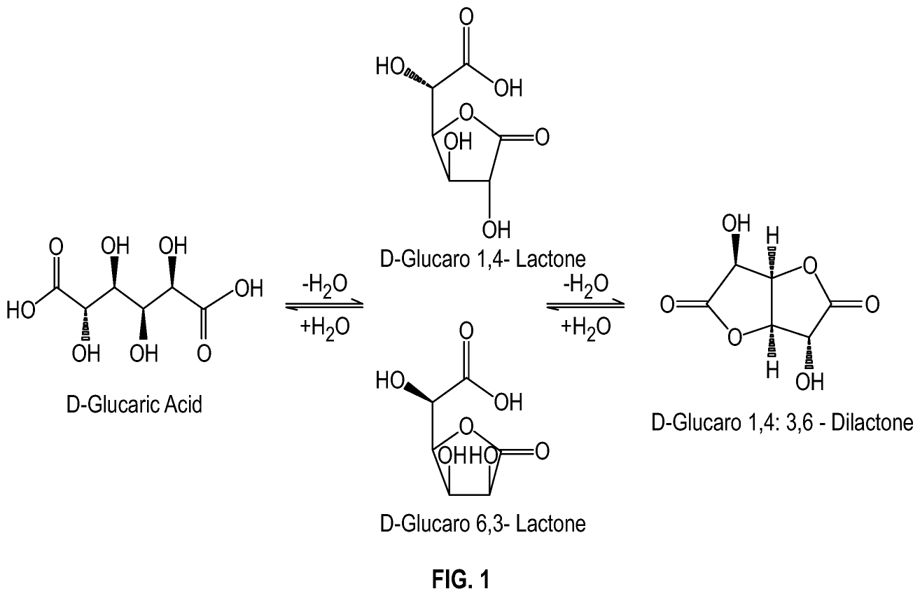

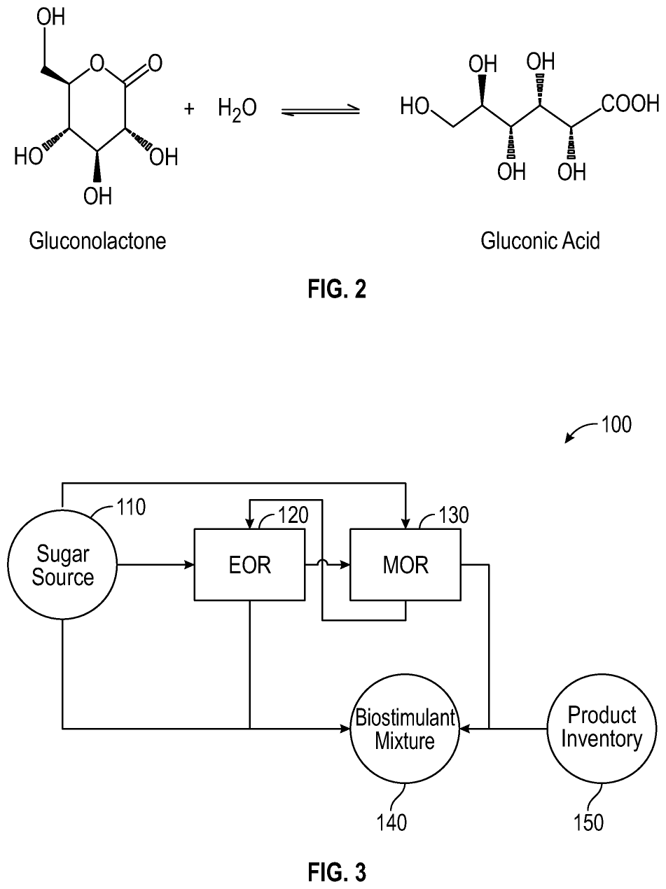

In an aspect, and not intending to be bound by theory, the PBC comprises a sugar derivative, such as an organic acid and its corresponding lactone. Such compounds may function to slowly acidify the soil to which it is applied, resulting in nutrients around the soil becoming more bioavailable to the plant seed. FIG. 1 depicts schematically a reaction mechanism for acidification using a PBC of the type disclosed herein. A second depiction of a PBC reaction leading to acidification of the environment to which it is introduced (e.g., soil) is depicted in FIG. 2. Referring to FIG. 2, lactones, such as gluconolactone, incorporate a water molecule and slowly acidifies the soil through the formation of gluconic acid. This slow acidification is especially useful in other applications such as food preservation as it prevents mold and bacteria growth.

In an aspect, a treatment composition comprising a PBC of the type disclosed herein (e.g., PBC, nutrient salt and vitamin) in either liquid or solid form is contacted with an agricultural material. For example, the agricultural material is at least a portion of a plant or a plant growth medium (e.g., soil). In one or more aspects, the treatment composition comprising a PBC of the type disclosed herein is contacted with the plant using any suitable methodology, such as and without limitation foliar, soil, fertigation, chemigation, irrigation, hydroponics, aeroponic, and indoor vertical farming.

In one or more aspects, the treatment composition comprising a PBC of the type disclosed herein is applied to the ground surrounding a plant or to the foliage of the plant using any suitable methodology to enhance plant viability. For example, the treatment composition comprising a PBC of the type disclosed herein may be contacted with plants by introduction to an irrigation composition for application by drip irrigation.

Other nonlimiting examples of methods for contacting the treatment composition comprising a PBC of the type disclosed herein with a plant include the direct spray of a diluted aqueous solution of the treatment composition on the leaves, stems, and fruits of a plant, injection of the treatment composition into the growing medium (e.g., soil), injection of the treatment composition into the water culture, circulation of the treatment composition past an absorbent such as rock wool which is held in direct contact with the roots of a plant, continuous addition of the treatment composition to the feed water of a plant, or combinations thereof. Additionally, or alternatively, the treatment composition may be incorporated into a solid material, such as a granular fertilizer or compressed fertilizer (e.g., a fertilizer “spike”) when may be applied to the ground proximate to a plant. Additionally, or alternatively, the treatment composition may be incorporated into herbicides and water softening components, such as a glyphosate, glufosinate, Dicamba, ammonium sulfate which may be applied to the ground proximate to a plant.

In an aspect, a treatment composition comprising a PBC of the type disclosed herein is applied directly to a soil to affect the pH of the soil. For example, the treatment composition comprising a PBC of the type disclosed herein may be applied to a soil having an alkaline pH to acidify the soil.

In aspects in which the treatment composition comprising a PBC of the type disclosed herein is a liquid, it may be sprayed or poured onto the base growing medium or it may be sprayed onto an above ground portion of the plant. In aspects in which the treatment composition is a solid, it may be spread onto the surface of the base growing medium or it may be mixed into the base growing medium. Herein, base growing medium refers to a standard material that is commonly used to grow plants, for example soil or compost. For example, in aspects, the treatment composition comprises a seed treatment which may be applied to a seed. Additionally or alternatively, the treatment composition may be contacted with a part of a plant that is above the ground, for example the leaves, flowers, fruit, or stem.

A PBC of the present disclosure can be used effectively in nanomolar concentrations. Consequently, the treatment compositions may be applied to virtually any variety of plant shoots, roots, seeds, tissues, suspension cultures, or thalli.

For example, the PBC may be applied in an amount ranging from about 0.01 quart per acre of plants to about 10 quart per acre of plants, alternatively from about 0.1 quart per acre of plants to about 5 quart per acre of plants, alternatively from about 1 quart per acre of plants to about 2 quart per acre of plants.

A schematic depiction of a system, 100, for the production a PBC is presented in FIG. 3. With reference to FIG. 3, a sugar source (e.g., corn syrup) is provided as the reactant to tank 110 which is conveyed to an Enzyme Oxidation Reactor (EOR) 120. The EOR 120 contains one or more enzymes capable of oxidizing the sugar source. The EOR 120 may be operated under any conditions suitable for the formation of an oxidized sugar source, hereinafter termed a first intermediate. The first intermediate from EOR 120 may then be conveyed to a Metal Oxidation Reactor (MOR) 130.

In an aspect, the MOR 130 comprises a metal catalyst, alternatively a transition metal catalyst, alternatively a noble metal catalyst, or alternatively a metal oxidation catalyst. In an aspect, the metal catalyst is a metal oxidation catalyst or a supported metal catalyst. The intermediate may be contacted with a metal oxidation catalyst in the MOR 130 under conditions suitable for oxidation of the first intermediate to form one or more components of a PBC or mixture thereof 140, which can be used or stored to provide product inventory 150.

The PBC can be applied to all photosynthetic organisms such as flowering plants, including angiosperms and gymnosperms, and cryptograms, including ferns, liverworts, mosses, algae, and hornworts. A PBC may be advantageously applied to higher plants, including species having true stems, roots and leaves.

Plants which may benefit from application of a PBC of the type disclosed herein may include, without limitation, generally, crops such cereals, pulses/legumes, vegetables. fruits, nuts, oilseeds, sugars and/or starches, fibrous crops, beverage plants, narcotics and medicinal plants, spices, condiments, rubber forages, and green manure. Examples of plants which may benefit from a PBC of the present disclosure include but are not limited to all crop plants such as alfalfa, anise, bach ciao, barley, basil, blueberry, breadfruit, broccoli, brussels sprouts, cabbage, cassava, cauliflower, celery, cereals, cilantro, clover, coffee, corn, cotton, cranberry, cucumber, dill, eggplant, fennel, grape, grain, garlic, kale, leek, legume, lettuce, melon, mint, mustard, melon, oat, onion, parsley, peanut, pepper, potato, saffron, legumes, lettuce, millet, parsnip, pea, pepper, peppermint, pumpkin, radish, rice, rye, sesame, sorghum, soy, spinach, squash, stevia, strawberry, sunflower, sweet potato, sugar beet, sugar cane, tea, tobacco, tomato, turnip, wheat, yam, zucchini and the like; pomes and other fruit-bearing plants such as apple, avocado, banana, breadfruit, cherry, citrus, cocoa, fig, guava, macadamia, mango, mangosteen, nut, olive, papaya, passion fruit, pear, pepper, plum, peach and the like; floral plants such as achillea, ageratum, alyssum, anemone, aquilegia, aster, azalea, begonia, bird-of-paradise, bleeding heart, borage, bromeliad, bougainvillea, buddlea, cactus, calendula, camellia, campanula, carex, carnation, celosia, chrysanthemum, clematis, cleome, coleus, cosmos, crocus, croton, cyclamen, dahlia, daffodil, daisy, day lily, delphinium, dianthus, digitalis, dusty miller, euonymus, forget-me-not, fremontia, fuchsia, gardenia, gazania, geranium, gerbera, gesneriad, ginkgo, gladiolus, hibiscus, hydrangea, impatiens, jasmine, lily, lilac, lisianthus, lobelia, marigold, mesembryanthemum, mimulus, myosotis, New Guinea Impatiens, nymphaea, oenothera, oleander, orchid, oxalis, pansy, penstemon, peony, petunia, poinsettia, polemonium, polygonum, poppy, portulaca, primula, ranunculus, rhododendron, rose, salvia, senecio, shooting star, snapdragon, solanum, solidago, stock, torenia, tulip, verbena, vinca, viola, violet, zinnia, and the like; leafy plants such as ficus, fern, hosta, philodendron, and the like, trees such as Abies, birch, cedar, Cornus, cypress, elm, fir, juniper, magnolia, mahogany, maple, oak, palm, Picea, Pinus, Pittossporum, Plantago, poplar, redwood, Salix, sycamore, Taxus, teak, willow, yew, Christmas tree and the like; grasses, such as Kentucky blue grass, bent grass, turf, festuca, pennisetum, phalaris, calamogrostis, elymus, helictotrichon, imperata, molina, carex, miscanthus, panicum and the like; and thalloid plants such as ferns and algae. Algae include seaweeds such as kelp, Eucheuma, laver, nori, kombu and wakame. Other plants, which may benefit from application of the PBC of the present disclosure will be apparent to those skilled in the art.

A PBC of the type disclosed herein can have distinct competitive advantages over incumbent technologies, as it addresses the fundamental issue with pH related solubility and product consistency.

Furthermore, PBCs of the present disclosure allow for the more effective use of nutrients that are already in-situ, as it allows higher mobilization of nutrients due to solubilization via slow acidification. In one or more aspects, a PBC of the type disclosed herein is combined advantageously with one or more sugars, oxides, sulfates, nitrates, chlorides, carbonates, or combination thereof.

In an aspect, a PBC of the type disclosed herein increases endogenous nutrient solubility via slow acidification. Typical biostimulants have low control over product quality as it's hard to achieve consistency over batch-to-batch with living organism such as microbes and plant extracts. A PBC of the type disclosed herein advantageously provides a chemical product with a consistent formulation and better control over product quality.

The PBCs disclosed herein may exhibit characteristics such as (i) consistent production quality; (ii) effectiveness in improving plant viability; (iii) ability to affect pH, (iv) a reduction in environmental impact on ecosystems and combinations thereof. In one or more aspects, the PBCs disclosed herein function to improve (i) seed germination, (ii) root growth, (iii) plant growth, (iv) yield potential, (v) plant's stress resistance, (vi) speed to maturity of plant and fruit set, (vii) marketable product quality, or any combination of (i) through (vii). PBCs of the present disclosure may be characterized by formulation stability.

In one or more aspects, plants treated with a PBC of the type disclosed herein exhibit an increase in germination of greater than about 10% when compared to an otherwise identical plant not treated with a PBC, alternatively the increase in germination ranges from about 10% to about 100%, alternatively from about 5% to about 30% or alternatively from about 50% to about 100%.

In one or more aspects, plants treated with a PBC of the type disclosed herein exhibit an increase in dry biomass growth of seedlings of greater than about 10% when compared to an otherwise identical plant not treated with a PBC, alternatively the increase in the dry biomass growth ranges from about 10% to about 100%, alternatively from about 20% to about 100% or alternatively from about 50% to about 100%.

In one or more aspects, plants treated with a PBC of the type disclosed herein exhibit an increase in fruit production of greater than about 10% when compared to an otherwise identical plant not treated with a PBC, alternatively the increase in fruit production ranges from about 10% to about 100%, alternatively from about 20% to about 100% or alternatively from about 50% to about 100%.

In one or more aspects, plants treated with a PBC of the type disclosed herein exhibit an increase in plant weight of greater than about 10% when compared to an otherwise identical plant not treated with a PBC, alternatively the increase in plant weight ranges from about 10% to about 50%, alternatively from about 20% to about 50% or alternatively from about 25% to about 50%.

In one or more aspects, plants treated with a PBC of the type disclosed herein exhibit an increase resistance to drought stress when compared to an otherwise identical plant not treated with a PBC. Herein drought stress refers to a condition stress resulting when water loss from a plant exceeds the ability of the plant's roots to absorb water and when the plant's water content is reduced enough to interfere with normal plant processes. An indication of stress due to drought is an increase in root length. Herein a product treated with a PBC of the type disclosed herein has root length decrease ranging from about 10% to about 75%, alternatively from about 15% to about 60% or alternatively from about 20% to about 50%.

Disclosed herein are PBCs which in one or more aspects functions in speeding up early plant growth such as in the seedling stage. This action unexpectedly and advantageously results in a shortened time to plant maturity and higher plant biomass when harvested.

### ADDITIONAL DISCLOSURE

A first aspect which is a composition comprising (i) a sugar, a sugar derivative or combination thereof; (ii) an optional nutrient salt; and (iii) an optional solvent.

A second aspect which is the composition of the first aspect wherein the sugar or sugar derivative comprises a buffered glucose oxidation product, a buffered gluconic acid oxidation product, aldaric acid, uronic acid, glucaric acid, gluconic acid, glucuronic acid, glucose oxidation products, gluconic acid oxidation products, disaccharides, oxidized disaccharides, n-keto-acids, C2-C6 diacids. galactonic acid, galactaric acid, glutamic acid, glucodialdose, 2-ketoglucose, glucodiamine, glycoaldehyde, glyoxal, salts thereof, lactones thereof or combinations thereof.

A third aspect which is the composition of any of the first through second aspects wherein the sugar or sugar derivative comprises monosaccharides, disaccharides, sucrose, glucose, fructose, lactose, maltose, xylose, ribose, arabinose, lyxose, trehalose, cellobiose, chitobiose, glucosamine, glucose disaccharides of alpha 1-2, glucose disaccharides of alpha 1-3, glucose disaccharides of alpha 1-6, glucose disaccharides of beta 1-2, glucose disaccharides of beta 1-3, glucose disaccharides of beta 1-6, glucose-fructose disaccharides of alpha 1-2, glucose-fructose disaccharides of alpha 1-3, glucose-fructose disaccharides of alpha 1-6, glucose-fructose disaccharides of alpha 1-5, glucose-fructose disaccharides of alpha 1-4, glucose-fructose disaccharides of beta 1-6, mannose disaccharides of alpha 1-2, mannose disaccharides of alpha 1-3, mannose disaccharides of alpha 1-4, mannose disaccharides of alpha 1-6, galactose disaccharides of alpha 1-6,glucose disaccharides of alpha 1-6, fructose disaccharides of alpha 1-6, rhamnose saccharides of alpha 1-6, glucose saccharides of alpha 1-6, fructose saccharides of alpha 1-6, fructose saccharides of beta 1-6, xylobiose disaccharides of beta 1-4, or combinations thereof.

A fourth aspect which is the composition of any of the first through third aspects wherein the sugar or sugar derivative comprises comprises less than about 5 wt. % maltose, maltotriose, fructose, higher molecular weight polysaccharides, oxidation products thereof or combinations thereof.

A fifth aspect which is the composition of any of the first through fourth aspects wherein the sugar or sugar derivative is present in an amount of from about 0.1 weight percent (wt. %) to about 99 wt. % based on the total weight of the composition.

A sixth aspect which is the composition of any of the first through fifth aspects wherein the nutrient salt comprises humic acids, fulvic acids, seaweed extract, other sugar derivatives, or combinations thereof.

A seventh aspect which is the composition of any of the first through sixth aspects wherein the nutrient salt is a macronutrient comprising nitrogen, phosphorus, potassium, calcium, magnesium, sulfur, or a combination thereof.

An eighth aspect which is the composition of any of the first through seventh aspects wherein the nutrient salt is a micronutrient comprising zinc, boron, manganese, molybdenum, copper, cobalt, nickel, iron, or a combination thereof.

A ninth aspect which is the composition of any of the first through eighth aspects wherein the nutrient salt comprises phosphates, phosphorous, chloride, sulfates, nitrates, nitrites, oxides, amino acids, or a combination thereof.

A tenth aspect which is the composition of any of the first through ninth aspects wherein the solvent comprises water, a citrate solution, methanol, ethanol, ethylene glycol, propylene glycol, ethylene glycol monobutyl ether, a hydroxide-based pH fluid, an ammonia solution, a urea solution, herbicides, water conditioner, adjuvants, or a combination thereof.

An eleventh aspect which is the composition of any of the first through tenth aspects further comprising a performance enhancing additive selected from the group consisting of oxides, nitrates, nitrites, phosphates, sulfates, potassium, insecticides, herbicides, fungicides, macronutrients, humectant, plant hormones, dry fertilizer, liquid fertilizers, adjuvants, surfactants, oxidizers, biologicals, vitamins, mold inhibitor, absorbent, penetrant, growth regulators, water treatment products, irrigation products, and plant hormones.

A twelfth aspect which is a method of treatment comprising contacting an agricultural material with a composition comprising (i) a sugar, a sugar derivative or combination thereof; (ii) an optional nutrient salt; (iii) an optional performance enhancing additive and (iv) a solvent wherein treatment of the agricultural material results in increased viability of a plant associated with the agricultural material.

A thirteenth aspect which is the method of the twelfth aspect wherein the sugar or sugar derivative comprises a buffered glucose oxidation product, a buffered gluconic acid oxidation product, aldaric acid, uronic acid, glucaric acid, gluconic acid, glucuronic acid, glucose oxidation products, gluconic acid oxidation products, disaccharides, oxidized disaccharides, n-keto-acids, C2-C6 diacids. galactonic acid, galactaric acid, glutamic acid, glucodialdose, 2-ketoglucose, glucodiamine, glycoaldehyde, glyoxal, salts thereof, lactones thereof or combinations thereof.

A fourteenth aspect which is the method of any of the twelfth through thirteenth aspects wherein the sugar or sugar derivative comprises comprises less than about 5 wt. % maltose, maltotriose, fructose, higher molecular weight polysaccharides, oxidation products thereof or combinations thereof.

A fifteenth aspect which is the method of any of the twelfth through fourteenth aspects wherein the agricultural material comprises a portion of a plant, a plant growth medium or a combination thereof.

A sixteenth aspect which is the method of any of the twelfth through fifteenth aspects wherein contacting comprises direct spray on the leaves, stems, direct spray on the fruits of a plant, injection into the growing medium, injection into the water culture, circulation past an absorbent in direct contact with the roots of a plant, addition to the feed water of a plant, or combinations thereof.

A seventeenth aspect which is the method of any of the twelfth through sixteenth aspects wherein the increased viability of a plant associated with the agricultural material is an increase in germination of from about 5% to about 100% when compared to a plant not contacted with the composition.

An eighteenth aspect which is the method of any of the twelfth through seventeenth aspects wherein the increased viability of a plant associated with the agricultural material is an increase in a plant dry biomass of from about 5% to about 100% when compared to a plant not contacted with the composition.

A nineteenth aspect which is the method of any of the twelfth through eighteenth aspects wherein the increased viability of a plant associated with the agricultural material is an increase in fruit production of from about 5% to about 100% when compared to a plant not contacted with the composition.

A twentieth aspect which is the method of any of the twelfth through nineteenth aspects wherein the increased viability of a plant associated with the agricultural material is an increased resistance to drought conditions.

A twenty-first aspect which is the method of any of the twelfth through twentieth aspects wherein the increased resistance to drought stress comprises a change in root length of less than about 20% in fruit production of from about 5% to about 100% when compared to a plant not contacted with the composition.

A twenty-second aspect which is the method of any of the twelfth through twenty-first aspects wherein the increased viability of a plant associated with the agricultural material exhibits (i) an increased growth in the early seedling stage and/or shortened time to (iii) plant maturity and/or (iv) fruit formation when compared to a plant not contacted with the composition.

### EXAMPLES

The subject matter having been generally described, the following examples are given as particular aspects of the disclosure and are included to demonstrate the practice and advantages thereof. Those of skill in the art should, in light of the present disclosure, appreciate that many changes can be made in the specific aspects which are disclosed and still obtain a like or similar result without departing from the scope of the subject matter of the instant disclosure. It is understood that the examples are given by way of illustration and are not intended to limit the specification of the claims to follow in any manner.

### Example 1

The effect of a PBC on seed germination was investigated. Specifically, microgreens radish was grown in hydroponic pots and their growth based on treatment with the indicated materials evaluated. The pots were started with approximately 400 seeds being scattered in each pot on a grow mat that sat above a water reservoir (˜150 mL). The pots were kept indoor at room temperature under artificial light.

On Day 1 after seeding, the water reservoir in the left two pots were treated with 1% of a PBC of type disclosed herein. A majority of radish seeds started germinating in the treated pots (87%) on Day 2, while the controls showed much less germination (64%), indicating that the PBC is an effective germination enhancer of seedlings. On Day 3, most of the radish seeds were germinated and started showing green leaves. In comparison, the four controlled pots on the right still had a significant amount of seeds that had not sprouted. On Day 4, the treated pots showed denser green population, compared to the untreated pots that have some young yellow roots and some seeds that have not been germinated yet. On Day 5, the radish in treated pots showed denser population and healthy growth compared to the control which was visible with thicker stems, deeper purple color in stems, and deeper green colors in leaves.

The results from Day 5 were quantitatively validated with higher iron content (ppm) in the treated radish's nutrition analysis. The nutrition analysis indicated very interesting and suprisingly advantageous results. In the microgreens that were treated, the following cations exhibited higher concentrations in the leaves: Fe, Mo, and Ni, the Fe, Mo, and Ni were unexpected since the only source of these cations are in the growth media itself, leading to the conclusion that the PBC allowed for higher mobilization and transport of these cations/metals from the growth media, to the water, and to the plants. The nutrition analysis was performed on the whole radish plant including root, stem, and leaves using method of Dumas Method (LECO CNS-2000) for total nitrogen and sulfur and AOAC 900.02b Ashing/Extraction EPA 6010a (ICP-OES) for the rest of elements.

On Day 8, the radishes were harvested. The root length, and biomass (dry weight of the whole plant in each pot) are summarized in Table 1. The reported root length is the averaged value of 10 different root measured from each pot right after harvest. The reported biomass is the dry weight of the whole radish grown in each pot after drying for 3 days.

TABLE 1

| Pot # | Treatment | Length of Root (cm) | Plant dry weight (g) |
|---|---|---|---|
| U1 | 1% treated | 2.34 ± 0.56 | 4.81 |
| U2 | Control | 7.09 ± 1.06 | 4.12 |
| U3 | Control | 8.35 ± 2.06 | 4.29 |
| L1 | 1% treated | 2.53 ± 0.54 | 4.97 |
| L2 | Control | 9.28 ± 3.16 | 4.66 |
| L3 | Control | 9.43 ± 1.58 | 4.24 |

As seen in the Table 1, the radish in the treated pot had much shorter roots (2.34-2.53 cm) when compared to the untreated one sample (7.09 cm-9.43 cm), indicating that the treated radish had sufficient nutritional uptake and did not need to develop long roots to look for more nutrients further away like the ones found in nutritionally-deficient plants (e.g., the Controls).

The biomass of the treated radish was also the highest (4.81-4.97 g) when compared to the untreated counterparts (4.12-4.66 g). The treated plants had approximately 13% higher dry weight than the untreated control. This increase in weight was quite significant and unexpected. This result indicates a PBC of the type disclosed herein promoted healthy plant growth and higher yield.

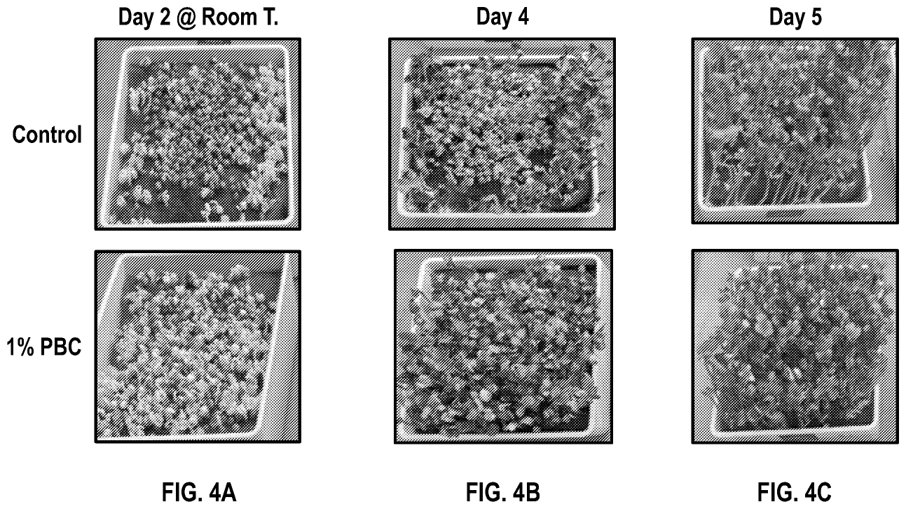

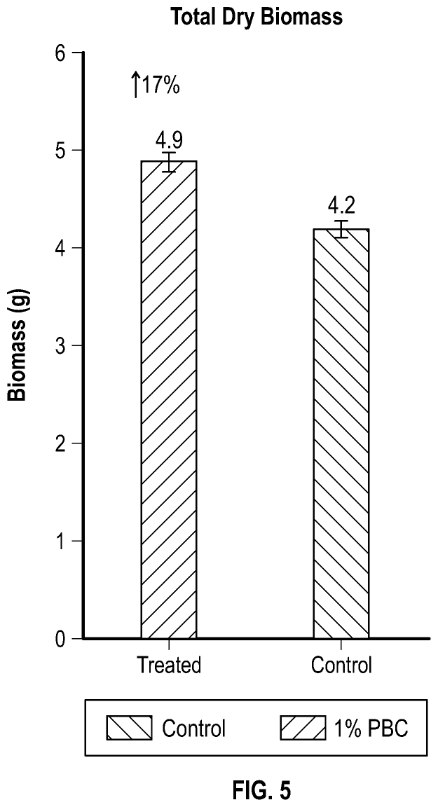

Representative photographs of plant growth as a function of time in the presence and absence of a PBC is presented in FIGS. 4A through 4C while a graph of the biomass and treated and control samples is presented in FIG. 5. With reference to FIG. 4A the samples treated with a PBC germinated faster than the control sample. The germination rate was observed to increase from 64% for the control sample to 87% for the PBC sample. With reference to FIG. 4B the samples treated with a PBC had a denser plant population when compared to control sample. With reference to FIG. 4C the samples treated with a PBC exhibited a 17% increased biomass, an increased number of green leaves (10%) and thicker and shorter shoots when compared to the control sample.

### Example 2

The biostimulant effect of a PBC under controlled pH and composition conditions was investigated. Particularly, a second batch of testing was performed to verify that biostimulant effect observed in Example 1 was not an artifact of differing pH or composition. In this set, samples having a controlled yet differing compositions were compared. The first sample set comprised the sugar sucrose while the second sample comprised citric acid. Citric acid was reported to promote seed germination, all under the same pH. Therefore, solutions of 1% citric acid, sucrose, and a PBC were prepared and adjusted to a pH of 5. Two pots were filled with 150 g of each solution. About 200 seeds were placed on top of each soaked growing mats. This second batch was left indoors at room temperature for 8 days.

On Day 1 most of the seeds had started to sprout. On Day 2, all pots had a germination rate of 98% or greater. Notably, the pots treated with sucrose and a PBC of the type disclosed herein were observed to have the most root hair development. These two treatments have a germination rate of 99% and 98.5% respectively. In contrast, pots treated with citric acid had minimal root hair development but had a germination rate of 100%.

For Day 3, all treatments had signs of green leaf growth while the pots treated with citric acid still lacked root hairs. Pots treated with sucrose and a PBC of the type disclosed herein had the most leaf development.

For Day 4, citric acid treated microgreens show signs of stunted growth with no stem or root hair development. Pots treated with sucrose had similar plant growth with those treated with a PBC of the type disclosed herein. Both PBC and sucrose treated microgreens has roots and showed stem growth.

On Day 7, stems of sucrose and PBC treated microgreens were of similar height. Both treatments also had healthy leaf growth. However, due to the presence of sucrose, a few fruit flies appeared at the location of the microgreens, which is the main reason why sucrose has not been widely used in the field as a biostimulant as it attracts pests who like sugars. On the other hand, no fruit flies appeared during the first batch of testing (see Example 1), which did not include a sucrose treatment. Therefore, it is unlikely that GOGA contributed to the appearance of these fruit flies as there were two pots treated with a PBC in Example 1. Citric acid treated radishes showed no stem development and poor overall growth at Day 7.

Microgreens were harvested on Day 8. The length of roots and stems were recorded for each pot and are presented in Table 2. They were then dried for 3 days, and the dry weights were recorded.

TABLE 2

| | | Length of | Length of | Plant dry |
|---|---|---|---|---|
| Pot # | Treatment | Root (cm) | Stem (cm) | weight (g) |
| 1A | 1% Sucrose | 2.61 ± 0.43 | 3.86 ± 1.10 | 3.0 |
| 1B | 1% Sucrose | 2.49 ± 1.0 | 4.27 ± 1.03 | 2.29 |
| 2A | 1% GOGA45¹ | 1.65 ± 0.61 | 3.91 ± 1.24 | 2.65 |
| 2B | 1% GOGA45 | 3.31 ± 1.03 | 4.53 ± 0.93 | 3.72 |
| 3A | 1% Citric Acid | 0.71 ± 0.22 | — | 1.81 |
| 3B | 1% Citric Acid | 0.82 ± 0.25 | — | 1.99 |

¹GOGA refers to a mixture of gluconic acid and glucaric acid.

As seen in Table 2, the microgreens treated with 1 wt. % citric acid had the least overall growth in every parameter considered: almost no growth of stem and root and the plant dry weight was mostly based on barely germinated young seedlings. In contrast, the microgreens with the sucrose and PBC had similar root and stem lengths. PBC treated plants showed slightly higher dry weight about 20.4% higher, than sucrose treated plants.

### Example 3

The biostimulant efficacy of PBCs of the type disclosed herein on seed germination was investigated. Specifically, a tray germination study was performed with tomato seeds under greenhouse conditions. One tomato seed was placed per cell—total 116 seeds in a tray. A pipette was used to treated tray media with a combination of PBCs at the rate of 1 qt of product in 100 gal of water (1 qt/gal per acre).

Accelerated seed germination was observed in the trays treated with a PBC when compared to the non-treated control in the first 9 days. Especially, the tray treated with a PBC showed significant increase in the germination rate by 48% compared to the control at Day 7.

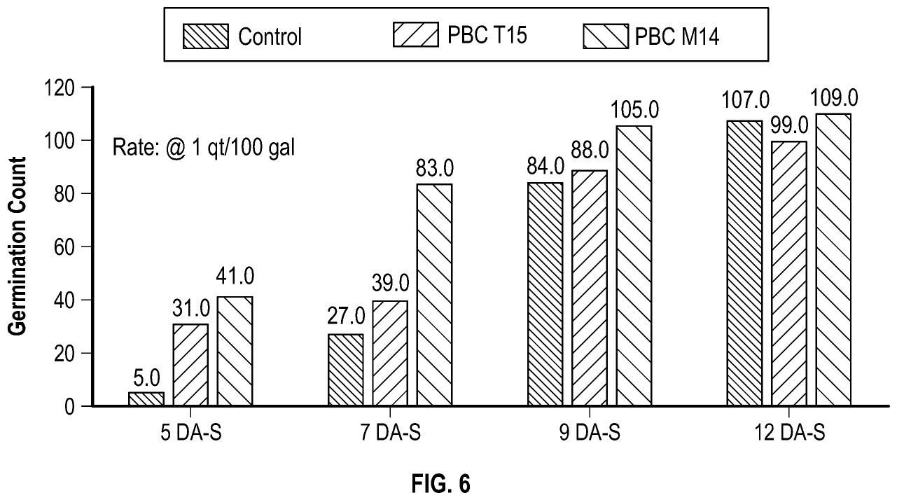

Seedlings 16 days after seeding showed that the trays treated with a PBC had more numbers of visible and relatively larger seedlings when compared to the control. The early germination provided the advantage of more time to grow for seedlings, resulting in a higher biomass in the seedling stage: specifically increased fresh seedling weight by 7-10% and dry biomass by 8-21% at 51 days after seeding. These results are presented graphically in FIG. 6.

### Example 4

The effect of a PBC on fruit production was investigated. Tomato plants were transplanted into pots (one plant per pot, 6 replicates per treatment) and placed in randomized network. Tomato was foliar sprayed every week with 1-2 qt/gal a combination of PBCs via spray bottle with 3 ml of solutions each time. Potting soil was used in 3 gallon pots with fertility program. Herein the fertility program refers to the use of plant feed comprising NPK fertilizer May 12, 2026 (5% nitrogen—12% phosphorous—26% potassium) and 15-0-0 (15% nitrogen—0% phosphorous—0% potassium). Drip irrigation was carried out three times a week.

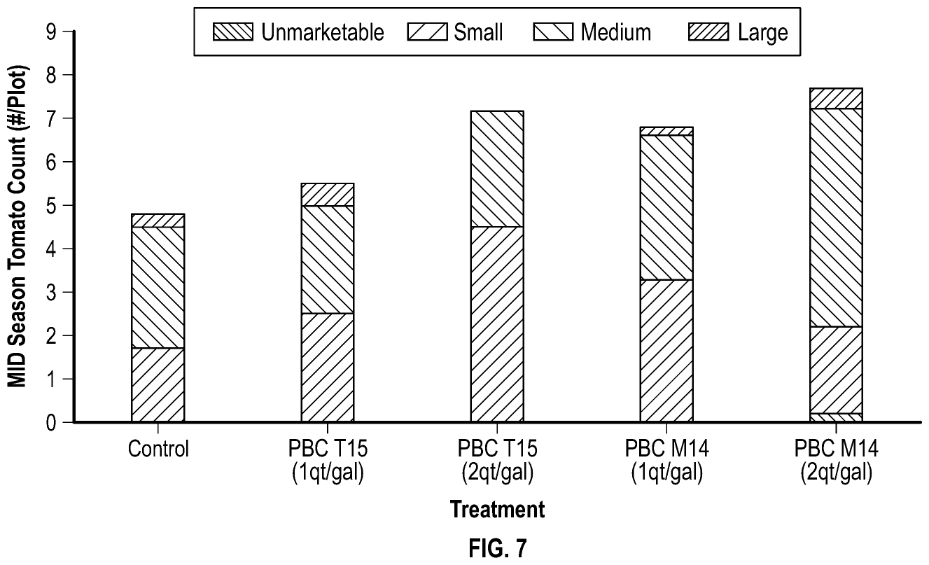

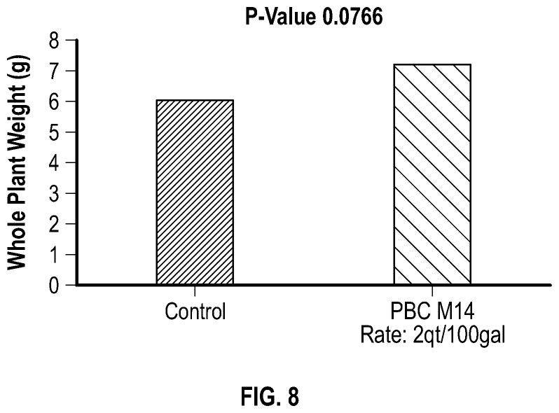

The tomato plants treated with a PBC showed an increase in the number of fruits compared to the control by 3 accumulatively from the 6 plants for each treatment during mid-season assessment. This is presented graphically in FIG. 7.

Overall, the result from the tomato greenhouse test suggests that one of the modes of action of PBCS as a biostimulant is promoting plant growth in early seedling stage through early germination, resulting to reach higher biomass early on, and therefore shortened the time to maturity in plant and fruit formation.

### Example 5

To test the biostimulant efficacy of PBCs, young romaine lettuce were transplanted into pots with 6 replicate per treatment and positioned in a randomized location. Treatments were applied using a spray bottle with approximately 2 mL of the solution (2 qt/gal) was sprayed per plant biweekly. Lettuce treated with a PBC of the type disclosed herein had a higher weight and larger size during med-season harvest after 6 foliar treatment. These results, presented graphically in FIG. 8, again suggests that one of the modes of action of PBCs of the type disclosed is promoting plant growth in early seedling stage, resulting higher biomass early on, and therefore shortening the time to maturity to harvest plants.

### Example 6

To test the biostimulant efficacy of a plant treated with a PBC under drought stress resistance, hydroponic radish was grown in pots (3 replicates per treatment) with tap water for six days until osmotic drought stress was introduced through 10% PEG 6000 in the water reservoir. The dose rate of the PBC was 0.1 wt. %.

On Days 4 and 5, the radish in the control pot showed complete exhaustion, laying flat, while the radish treated with PBCs of the type disclosed here are withstood for the most part under severe drought stress condition.

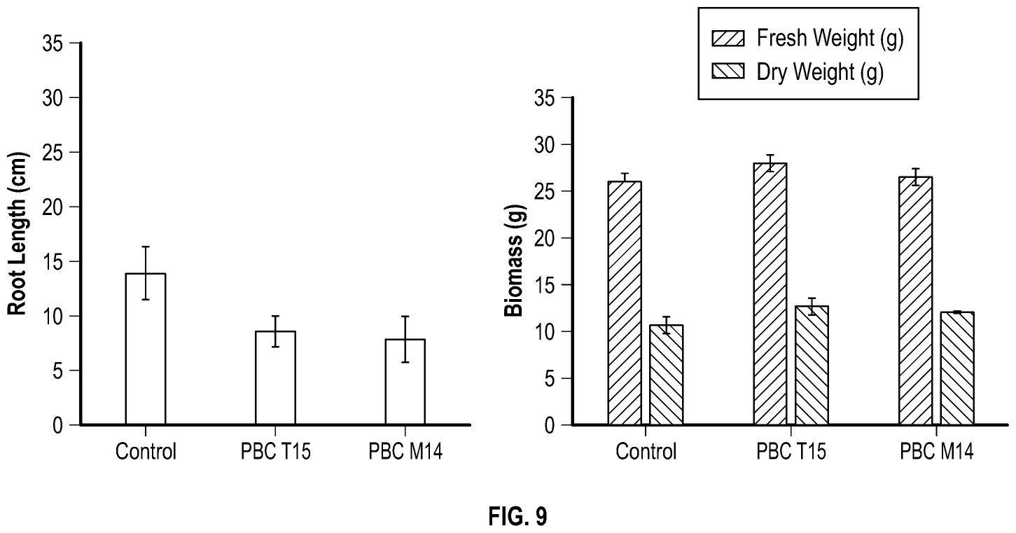

After 6 days of PEG induced drought stress, the plants were analyzed for the length of roots and biomass. A graph of (a) length of roots and (b) biomass of the radish plants under PEG induced drought stress when treated with PBCs is presented in FIG. 9.

With reference to FIG. 9, the radish in the control pots showed longer length of roots than the radish treated with PBCs, indicating that the radish in the treated pot had more nutrients available. Also, a trend was observed that the fresh weight and dry weight of radish in the treated pots were relatively higher, indicating that PBCs helped radish to be manage drought stress better, and therefore the radish retained more water inside the plant and built more biomass than the control.

While aspects of the disclosure have been shown and described, modifications thereof can be made without departing from the spirit and teachings of the presently disclosed subject matter. The aspects and examples described herein are exemplary only, and are not intended to be limiting. Many variations and modifications of the subject matter disclosed herein are possible and are within the scope of the present disclosure.

At least one aspect is disclosed and variations, combinations, and/or modifications of the aspect(s) and/or features of the aspect(s) made by a person having ordinary skill in the art are within the scope of the disclosure. Alternative aspects that result from combining, integrating, and/or omitting features of the aspect(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, 5, 6, . . . ; greater than 0.10 includes 0.11, 0.12, 0.13, 0.14, 0.15, . . . ). For example, whenever a numerical range with a lower limit, RI, and an upper limit, Ru, is disclosed, any number falling within the range is specifically disclosed. In particular, the following numbers within the range are specifically disclosed: R=RI+k* (Ru-RI), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the detailed description of the presently disclosed subject matter.

1. A composition, comprising:
(i) a sugar, a sugar derivative or combination thereof;
(ii) an optional nutrient salt; and
(iii) an optional solvent.

2. The composition of claim 1, wherein the sugar or sugar derivative comprises a buffered glucose oxidation product, a buffered gluconic acid oxidation product, aldaric acid, uronic acid, glucaric acid, gluconic acid, glucuronic acid, glucose oxidation products, gluconic acid oxidation products, disaccharides, oxidized disaccharides, n-keto-acids, C₂-C₆ diacids, galactonic acid, galactaric acid, glutamic acid, glucodialdose, 2-ketoglucose, glucodiamine, glycoaldehyde, glyoxal, one or more salts thereof, one or more lactones thereof, or a combination thereof.

3. The composition of claim 1, wherein the sugar or sugar derivative comprises monosaccharides, disaccharides, sucrose, glucose, fructose, lactose, maltose, xylose, ribose, arabinose, lyxose, trehalose, cellobiose, chitobiose, glucosamine, glucose disaccharides of alpha 1-2, glucose disaccharides of alpha 1-3, glucose disaccharides of alpha 1-6, glucose disaccharides of beta 1-2, glucose disaccharides of beta 1-3, glucose disaccharides of beta 1-6, glucose-fructose disaccharides of alpha 1-2, glucose-fructose disaccharides of alpha 1-3, glucose-fructose disaccharides of alpha 1-6, glucose-fructose disaccharides of alpha 1-5, glucose-fructose disaccharides of alpha 1-4, glucose-fructose disaccharides of beta 1-6, mannose disaccharides of alpha 1-2, mannose disaccharides of alpha 1-3, mannose disaccharides of alpha 1-4, mannose disaccharides of alpha 1-6,galactose disaccharides of alpha 1-6, glucose disaccharides of alpha 1-6, fructose disaccharides of alpha 1-6, rhamnose saccharides of alpha 1-6, glucose saccharides of alpha 1-6, fructose saccharides of alpha 1-6, fructose saccharides of beta 1-6, xylobiose disaccharides of beta 1-4, or a combination thereof.

4. The composition of claim 1, wherein the sugar or sugar derivative comprises less than about 5 wt. % maltose, maltotriose, fructose, higher molecular weight polysaccharides, one or more oxidation products thereof, or a combination thereof.

5. The composition of claim 1, wherein the sugar or sugar derivative is present in an amount of from about 0.1 weight percent (wt. %) to about 99 wt. % based on the total weight of the composition.

6. The composition of claim 1, wherein the nutrient salt comprises humic acids, fulvic acids, seaweed extract, other sugar derivatives, or a combination thereof.

7. The composition of claim 1, wherein the nutrient salt is a macronutrient comprising nitrogen, phosphorus, potassium, calcium, magnesium, sulfur, or a combination thereof.

8. The composition of claim 1, wherein the nutrient salt is a micronutrient comprising zinc, boron, manganese, molybdenum, copper, cobalt, nickel, iron, or a combination thereof.

9. The composition of claim 1, wherein the nutrient salt comprises phosphates, phosphorous, chloride, sulfates, nitrates, nitrites, oxides, amino acids, or a combination thereof.

10. The composition of claim 1, wherein the solvent comprises water, a citrate solution, methanol, ethanol, ethylene glycol, propylene glycol, ethylene glycol monobutyl ether, a hydroxide-based pH fluid, an ammonia solution, a urea solution, herbicides, water conditioner, adjuvants, or a combination thereof.

11. The composition of claim 1, further comprising a performance enhancing additive selected from the group consisting of oxides, nitrates, nitrites, phosphates, sulfates, potassium, insecticides, herbicides, fungicides, macronutrients, humectant, plant hormones, dry fertilizer, liquid fertilizers, adjuvants, surfactants, oxidizers, biologicals, vitamins, mold inhibitor, absorbent, penetrant, growth regulators, water treatment products, irrigation products, and plant hormones.

12. A method of treatment, comprising:
contacting an agricultural material with a composition comprising:
(i) a sugar, a sugar derivative or combination thereof;
(ii) an optional nutrient salt;
(iii) an optional performance enhancing additive and
(iv) a solvent wherein treatment of the agricultural material results in increased viability of a plant associated with the agricultural material.

13. The method of claim 12, wherein the sugar or sugar derivative comprises a buffered glucose oxidation product, a buffered gluconic acid oxidation product, aldaric acid, uronic acid, glucaric acid, gluconic acid, glucuronic acid, glucose oxidation products, gluconic acid oxidation products, disaccharides, oxidized disaccharides, n-keto-acids, C₂-C₆ diacids. galactonic acid, galactaric acid, glutamic acid, glucodialdose, 2-ketoglucose, glucodiamine, glycoaldehyde, glyoxal, one or more salts thereof, one or more lactones thereof, or a combination thereof.

14. The method of claim 12, wherein the sugar or sugar derivative comprises less than about 5 wt. % maltose, maltotriose, fructose, higher molecular weight polysaccharides, one or more oxidation products thereof, or a combination thereof.

15. The method of claim 12, wherein the agricultural material comprises a portion of a plant, a plant growth medium, or a combination thereof.

16. The method of claim 12, wherein contacting comprises direct spray on the leaves, stems, direct spray on the fruits of a plant, injection into the growing medium, injection into the water culture, circulation past an absorbent in direct contact with the roots of a plant, addition to the feed water of a plant, or a combination thereof.

17. The method of claim 12, wherein the increased viability of a plant associated with the agricultural material is an increase in germination of from about 5% to about 100% when compared to a plant not contacted with the composition.

18. The method of claim 12, wherein the increased viability of a plant associated with the agricultural material is an increase in a plant dry biomass of from about 5% to about 100% when compared to a plant not contacted with the composition.

19. The method of claim 12, wherein the increased viability of a plant associated with the agricultural material is an increase in fruit production of from about 5% to about 100% when compared to a plant not contacted with the composition.

20. The method of claim 12, wherein the increased viability of a plant associated with the agricultural material is an increased resistance to drought conditions.

21. The method of claim 12, wherein the increased resistance to drought stress comprises a change in root length of less than about 20% in fruit production of from about 5% to about 100% when compared to a plant not contacted with the composition.

22. The method of claim 12, wherein the increased viability of a plant associated with the agricultural material exhibits (i) an increased growth in the early seedling stage and/or shortened time to (ii) plant maturity and/or (iii) fruit formation when compared to a plant not contacted with the composition.
